(19) United States
(12) Patent Application Publication
(10) Pub. No.: US 2024/0378417 A1
(43) Pub. Date: Nov. 14, 2024

(54) METHODS AND SYSTEMS FOR IMPLICIT ATTENTION WITH SUB-QUADRATIC COMPLEXITY INARTIFICIAL NEURAL NETWORKS

(71) Applicant: APPLIED BRAIN RESEARCH INC., Waterloo (CA)

(72) Inventors: Narsimha CHILKURI, Waterloo (CA); Eric HUNSBERGER, Scarborough (CA); Aaron VOELKER, Waterloo (CA); Christopher David ELIASMITH, Waterloo (CA)

(21) Appl. No.: 18/693,730

(22) PCT Filed: Sep. 20, 2022
(86) PCT No.: PCT/CA2022/051395

§ 371 Date: Mar. 20, 2024

Related U.S. Application Data
(60) Provisional application No. 63/246,174, filed on Sep. 20, 2021.

(51) Int. Cl. G06N 3/044

(52) U.S. Cl. CPC G06N 3/044

(57) ABSTRACT

The present invention relates to methods and systems for implicitly computing pairwise sequence attention scores with sub-quadratic complexity in artificial neural networks. More specifically, the present application discloses an “implicit attention” mechanism that computes a pairwise attention score on the output of a neural network at each step in an input sequence, rather than across these steps. This implicit attention mechanism operates by taking the output vector produced by a neural network layer for a given sequence step, reshaping this vector into a matrix, and then transforming this matrix on the basis of pairwise similarities between its rows and columns, so as to produce an output vector that stores a compressed summary of all of the sequential dependencies present in the input sequence that are relevant for performing at least one classification, regression, or data generation task.

### (1) FIELD OF THE INVENTION

The present invention generally relates to the field of processing sequential data with artificial neural networks, and more specifically to improving the local sequence processing capabilities and efficiency of these networks by implicitly computing pairwise sequence attention scores for the purpose of modeling dependencies between different sequence elements in the context of data processing tasks.

### (2) BACKGROUND OF THE INVENTION

One of the most important recent advances in machine learning involves the use of “self-attention” mechanisms in large-scale artificial neural networks. These mechanisms have been shown to drastically improve the performance of neural network models on a wide range of sequential data processing tasks, and are widely used in the domains of natural language processing, automatic speech recognition, and image generation. Given a sequence of input vectors, a self-attention mechanism computes, for every sequence position, a weighted average of the input vectors for all other sequence positions with a weight proportional to a similarity score (i.e., the inner product) between these vectors. By computing all pairwise interactions between vectors in an input sequence, a neural network with self-attention is able to learn complex dependencies between the items in this sequence, and thus provide improved performance on a range of regression, classification, and data generation tasks.

The most common implementations of self-attention are found in “transformer” neural network models, which stack multiple layers of self-attention blocks to create network modules for both encoding inputs into latent representations, and decoding these latent representations to perform various data processing tasks. Because transformers typically do not include recurrently connected layers, the computations they perform can be executed entirely in parallel, thus enabling deployment on hardware accelerators such as graphics processing units (GPUs). The use of GPU-based acceleration has made training transformers on extremely large datasets feasible, which in turn has produced drastic qualitative and quantitative improvements in performance on language modeling tasks in particular.

One downside of transformer-style neural networks is that the computation of attention scores scales quadratically with respect to the length of the network's input sequence. In practice, this quadratic scaling limits the length of the sequences that transformers are able to process, with a typical maximum on the order of one thousand sequence elements. Another downside is that while purely attention-based networks are effective at capturing long-range dependencies, they show suboptimal performance in some problem domains (e.g., speech recognition) that involve data dependencies operating over relatively short time scales. Overall, efforts to exploit and improve the use of self-attention mechanisms in artificial neural networks has led to a number of systems for processing sequential data being defined in prior art. As such, the following documents and patents are provided for their supportive teachings and are all incorporated by reference: Vaswani et. al. (Vaswani, Ashish et. al. “Attention is All you Need”, NeurIPS (2017)) discloses the basic design of the self-attention mechanism, and provides experimental evidence of its superiority over more traditional recurrent neural network models in the context of an automated language translation task.

Another prior art document, Devlin et. al. (Devlin, Jacob et. al. “BERT: Pretraining Deep Bidirectional Transformers for Language Understanding”, NeurIPS (2018)) discloses a mask-based training method for use with transformer models, and demonstrates that this training method yields extremely high performance on a natural language processing tasks such as sentiment analysis, semantic similarity evaluation, and inference classification. BERT-style models are now the de facto standard for most classification-based language processing tasks, and related models have been developed to achieve state-of-the-art results in other problem domains involving, for example, image classification and protein structure prediction.

A further prior art document, Brown et. al. (Brown, Tom et. al. “Language Models are Few-Shot Learners”, Arxiv (2020)) discloses an auto-regressive training method for use with transformer models that enables them to generate extremely high-quality natural language output in response to short text prompts. Because this training method can be parallelized in keeping with the architectural design of the self-attention mechanism, the method can be applied with massive datasets on the order of several hundred gigabytes, leading to substantially improved language generation quality. However, the methods and systems described in the aforementioned references and many similar references are all subject to the constraint of quadratic scaling in terms of computation and memory usage with respect to the length of a given system's input sequence. More specifically, the existing state-of-the-art provides little in the way of methods for building self-attention mechanisms that maintain high-quality model performance while achieving sub-quadratic computational complexity.

The present application addresses these concerns and shortcomings by defining methods and systems for implicitly computing pairwise sequence attention scores with sub-quadratic complexity in artificial neural networks. More specifically, the present application discloses an “implicit attention” mechanism that computes a pairwise attention score on the output of a neural network at each step in an input sequence, rather than across these steps. In order to compute attention scores locally in this step-by-step manner, the implicit attention mechanism is used in tandem with a neural network layer whose outputs at each time-step can be separated into a two-dimensional matrix with spatial and temporal axes. Pairwise attention scores are then computed for the spatial axis using the row vectors corresponding to the temporal axis of the matrix, thereby creating a new set of spatial representations that weighted averages of these row vectors. These spatial representations are then projected down to the same dimensionality as the input to the neural network for a given timestep, thus providing a clean transformation from a sequence of n d-dimensional input vectors to a sequence of n d-dimensional output vectors. For a range of neural network models that use linear recurrent layers and convolutional layers to produce a matrix with spatial and temporal axes at each time step, the overall computational complexity of these models is either linear or log-linear rather than quadratic. This computational complexity results in significantly improved training efficiency and model performance across a range of automated language processing and speech recognition tasks.

### (3) SUMMARY OF THE INVENTION

In the view of the foregoing limitations inherent in the known methods for implementing self-attention mechanisms in artificial neural networks, the present invention provides methods and systems for implicitly computing pairwise sequence attention scores with sub-quadratic complexity in artificial neural networks. These methods and systems involve the use of a neural network layer that processes a sequence of input vectors such that for every vector in the sequence, the layer produces as output a matrix that has axes corresponding to spatial and temporal components of the information in the input sequence. Attention scores are computed across the temporal components of this matrix, thereby implementing an implicit version of attention over the original items in the input sequence. The reason the attention mechanism is implicit is because attention scores are computed over local representations of the history of this sequence rather than on the sequence items themselves (as is the case in a standard attention mechanism). The outputs of this implicit attention mechanism are then projected down to the dimensionality of the input vectors before being passed on to subsequent neural network layers for the purposes of performing at least one regression, classification, or data generation task. Most importantly, because all attention scores are computed locally for each step in the input sequence, no pairwise computations across all sequence steps are performed, thereby avoiding the need for quadratic computational complexity. As such, the general purpose of the present invention, which will be described subsequently in greater detail, is to provide methods and systems for implicitly computing pairwise sequence attention scores with sub-quadratic complexity in artificial neural networks.

The main aspect of the present invention is to define methods and systems for implicitly computing pairwise sequence attention scores with sub-quadratic complexity in artificial neural networks. The methods consist of defining at least one preprocessing layer that takes in a sequence of input vectors and produces, for each input vector, an output vector that is reshaped into a matrix with one dimension corresponding to spatial information and the other corresponding to temporal information, such that the layer implements either a linear recurrent neural network, a non-linear recurrent neural network, or a convolutional neural network. The methods further comprise defining at least one ‘implicit-attention’ layer that processes the output matrix of the at least one preprocessing layer by creating two (or three) copies of this output matrix and multiplying each copy on the right by two learned matrices to produce two intermediate matrices; these intermediate matrices are then multiplied together to form a square matrix whose elements represent pairwise similarities between all of rows of the intermediate matrices. These pairwise similarities are then used to create a new output matrix by providing weights over basis to determine the rows of this new matrix, which is passed through zero or more additional neural network layers to provide a final output vector. Finally, the methods disclose operating the resulting artificial neural network by mapping some number of input vectors onto some number of output vectors to perform at least one pattern classification, signal processing, data representation, or data generation task.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (4) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of an artificial neural network model architecture that implements the disclosed implicit attention mechanism.

FIG. 2 is an illustration of the improvements in neural network model performance that are observed when using the disclosed implicit attention mechanism.

### (5) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

For simplicity and clarity of illustration, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments of the artificial neural networks described herein may be implemented in configurable hardware (i.e., an FPGA) or custom hardware (i.e., an ASIC), or a combination of both with at least one interface. The input signal is consumed by the digital circuits to perform the functions described herein and to generate the output signal. The output signal is provided to one or more adjacent or surrounding systems or devices in a known fashion.

As used herein the term ‘node’ in the context of an artificial neural network refers to a basic processing element that implements the functionality of a simulated ‘neuron’, which may be a spiking neuron, a continuous rate neuron, or an arbitrary linear or non-linear component used to make up a distributed system.

The described systems can be implemented using adaptive or non-adaptive components. The system can be efficiently implemented on a wide variety of distributed systems that include a large number of non-linear components whose individual outputs can be combined together to implement certain aspects of the system as will be described more fully herein below.

The main embodiment of the present invention is a set of methods and systems for implicitly computing pairwise sequence attention scores with sub-quadratic complexity in artificial neural networks. The methods consist of defining at least one preprocessing layer that takes in a sequence of input vectors and produces, for each input vector, an output vector that is reshaped into a matrix with one dimension corresponding to spatial information and the other corresponding to temporal information, such that the layer implements either a linear recurrent neural network, a non-linear recurrent neural network, or a convolutional neural network. The methods further comprise defining at least one ‘implicit-attention’ layer that processes the output matrix of the at least one preprocessing layer by creating two (or three) copies of this output matrix and multiplying each copy on the right by two learned matrices to produce two intermediate matrices; these intermediate matrices are then multiplied together to form a square matrix whose elements represent pairwise similarities between all of rows of the intermediate matrices. These pairwise similarities are then used to create a new output matrix by providing weights over basis to determine the rows of this new matrix, which is passed through zero or more additional neural network layers to provide a final output vector. Finally, the methods disclose operating the resulting artificial neural network by mapping some number of input vectors onto some number of output vectors to perform at least one pattern classification, signal processing, data representation, or data generation task.

The term ‘attention mechanism’ here refers to a neural network module that takes in a sequence of n d-dimensional input vectors (i.e., an n×d matrix), and multiples them by “query” and “key” matrices. The outputs of these matrix multiplications are then themselves multiplied together to produce an n×n “attention” matrix which scores the pairwise similarities between each vector in the input sequence. The attention matrix is then multiplied by an n×d “value” matrix to produce a sequence of n d-dimensional output vectors. The term “self-attention” refers to an attention mechanism that computes pairwise attention scores between items in a single input sequence as just described. Other attention mechanisms compute attention scores between pairs of items drawn from separate sequences.

The term ‘implicit attention’ here refers to an attention mechanism that computes pairwise similarity scores across the rows or columns of a matrix that is generated by a neural network layer using each item in sequence of input vectors. Implicit attention thereby operates on a local matrix corresponding to a single step in a neural network's input sequence, rather than on a global matrix corresponding to all of the steps in this sequence. Typically, linear projections are used to maintain a low dimensionality for the results of these local matrix transformations, thereby reducing the overall computational complexity of implicit attention in comparison to standard self-attention.

The term ‘multi-headed self attention’ here refers to a self-attention mechanism that computes outputs for multiple “key”, “query”, and “value” parameter matrices in parallel using a single matrix of n d-dimensional input vectors. Each triplet of these key, query, and value matrices defines an “attention head” that learns to model a different set of dependencies between the items in the input sequence. Adding multiple attention heads to a neural network model with an attention mechanism accordingly increases its expressive power and its ability to learn more complicated mappings between sequences of input data and target output values.

The term ‘recurrent connection’ here refers to a set of weighted connections that transfer the output of one or more nodes in a given network layer back as input to one or more nodes in the same layer. The term ‘recurrently connected artificial neural network’ refers to a neural network with one or more recurrent connections. Recurrent connections typically introduce a sequential bottleneck when computing layer output values from a sequence of inputs, since the activation values at a given point in the sequence depend on the values computed for all previous steps in the sequence. Alleviating this sequential bottleneck is necessary in order to fully take advantage of specialized hardware devices such as GPUs that accelerate neural network computations by parallelizing them across a large number of relatively simple processing elements.

The term ‘activation function’ here refers to any method or algorithm for applying a linear or nonlinear transformation to some input value to produce an output value in an artificial neural network. Examples of activation functions include the identity, rectified linear, leaky rectified linear, thresholded rectified linear, parametric rectified linear, sigmoid, tanh, softmax, log softmax, max pool, polynomial, sine, gamma, soft sign, heaviside, swish, exponential linear, scaled exponential linear, and gaussian error linear functions. The term “linear network layer” here refers to any layer in an artificial neural network that computes its output values using a linear activation function such as the identity function.

Activation functions may optionally output ‘spikes’ (i.e., one-bit events), ‘multi-valued spikes’ (i.e., multi-bit events with fixed or floating bit-widths), continuous quantities (i.e., floating-point values with some level of precision determined by the given computing system—typically 16, 32, or 64-bits), or complex values (i.e., a pair of floating point numbers representing rectangular or polar coordinates). These aforementioned functions are commonly referred to, by those of ordinary skill in the art, as ‘spiking’, ‘multi-bit spiking’, ‘non-spiking’, and ‘complex-valued’ neurons, respectively. When using spiking neurons, real and complex values may also be represented by one of any number of encoding and decoding schemes involving the relative timing of spikes, the frequency of spiking, and the phase of spiking. However, it will be understood by those of ordinary skill in the art that the embodiments described herein may be practiced without these specific details.

The term ‘convolution’ here refers to the mathematical operation that takes two functions as input, and produces a third function as output that evaluates to the integral of the product of the two input functions over all possible shifts of one of the functions after it has been reversed. In many signal processing applications, the input functions are functions of time, and the integral is accordingly an integral over the products of these functions evaluated in the ‘time-domain’. It is also possible to perform convolution when the functions are expressed as weighted combinations of more basic signal frequencies. With this ‘frequency domain’ representation of the input functions, convolution is defined simply as an element-wise product.

The term ‘loss metric’ here refers to a scalar output value that is to be minimized by the computations of an artificial neural network. Examples of loss metrics include mean-squared error (MSE), cross-entropy loss (categorical or binary), Kullback-Leibler divergence, cosine similarity, and hinge loss. A loss metric is computed using a loss function that produce the metrics from one or more inputs; these inputs may consist of externally supplied data, outputs computed by nodes in an artificial neural network, supervisory and reward signals, the state of a dynamical system, or any combination thereof.

The nonlinear components of the aforementioned systems can be implemented using a combination of adaptive and non-adaptive components. Examples of nonlinear components that can be used in various embodiments described herein include simulated/artificial neurons, FPGAs, GPUs, and other parallel computing systems. Components of the system may be implemented using a variety of standard techniques such as by using microcontrollers. In addition, non-linear components may be implemented in various forms including software simulations, hardware, or any neuronal fabric. Non-linear components may also be implemented using neuromorphic computing devices such as Neurogrid, SpiNNaker, Loihi, and TrueNorth.

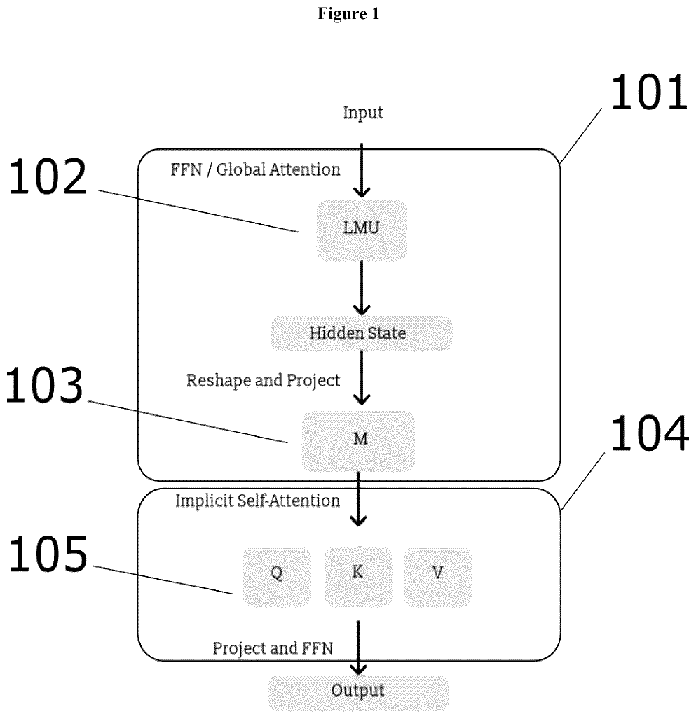

As an illustrative embodiment of the proposed systems and methods, consider the neural network model outlined in FIG. 1. This network consists of two high-level

modules, the first of which takes in a sequence of vectors of dimension ‘d’ as input, {x₁, x₂, . . . , xₙ}, and outputs another sequence of vectors, {y₁, y₂, . . . , yₘ}, as output, where each y is a vector that can be reshaped into a matrix with temporal and spatial axes. Any neural network layer that can be configured to output a set of vectors, where each individual vector can be reshaped into a matrix such that one of the dimensions corresponds to the temporal information and the other dimension corresponds to the spatial information, can be used as this first module. A non-exhaustive list of the types of neural network layers than can be used to implement this first module include the following:
Non-linear recurrent neural networks (RNNs): Consider a non-linear RNN such as the standard long short-term memory network (LSTM). Suppose it contains ‘q’ units and is configured to input one-dimensional sequences. Feeding the sequence of input vectors, {x₁, x₂, . . . , xₙ}, one dimension at a time, i.e., {xⁱ₁, xⁱ₂, . . . , xⁱₙ}, into the LSTM results in an output {yⁱ₁, yⁱ₂, . . . , yⁱₘ}, where each individual vector contains ‘q’ elements, and because the inputs are d-dimensional, there will be d-many of these sequences. Therefore, at each time-step, stacking d-many of these outputs to form a memory matrix Mₜ of size q×d, we end up with a matrix where the first dimension contains spatial information and the second contains temporal information. The same procedure can be repeated for any other non-linear recurrent neural network type. Additionally, a stack of these RNNs can be used instead of just one to compute the output states. For example, using as many RNNs as there are dimensions in the input, i.e., d such that we have {RNN₁, RNN₂, . . . , RNN_{d}}, each dimension of the input can be fed into a different RNN, and the outputs from various RNNs can be gathered to construct the final matrix Mₜ in a similar manner as before.
Linear RNNs: A linear RNN or a stack of linear RNNs can be used to obtain the M matrices, like in the above case. The weights inside the RNN can either be initialized randomly or chosen from the the set of discrete or continuous Legendre Transform (transforms using the Legendre polynomials), Fourier Transform, Hadamard Transform, Haar Transform, Laplace Transform, Cosine Transform, Fourier-Stieltjes, Gelfand transform, or Hartley Transform. When the weights are not only initialized to one of the basis functions from above but also frozen during training, the computation in the linear RNN can be parallelized during training, which can lead to significant speedups in training (Chilkuri and Eliasmith, “Parallelizing Legendre Memory Unit Training”, ICLR (2021)). In FIG. 1, a linear recurrent neural network called a Legendre Memory Unit or LMU

is used as part of the illustrative embodiment (Voelker, Aaron et al. “Legendre Memory Units: Continuous Time Representation in Recurrent Neural Networks” NeurIPS (2019)).
1 Convolution: A 1D convolution layer or a stack of them can be applied individually to the input dimensions to obtain the M matrices. For example, using q filters in each convolution layer would allow us to construct, at each time-step, an Mt matrix that is of shape q×d, just as in the case with RNNs.

The second module implements implicit self-attention on the M matrices produced for each item in the input sequence by the first module. This implicit self-attention mechanism operates locally on a matrix computed for each item in the input sequence, and thus does not directly on the input sequence; rather, it acts on a compressed representation of the history of this sequence at each step in the form of a matrix Mₜ. Ignoring optional network features such bias vectors, normalization layers, and skip-connections, the implicit attention module computes to following operations simultaneously:

Qₜ=σ(MₜR₁); K=σ(MₜR₂); V=σ(MₜR₃),

where Rᵢ is in R^{d×d}, σ could be a non-linearity such as gelu or an identity function, and the resulting matrices Q, K, V are all in R^{q×d}. Then, if it is considered beneficial to reduce the temporal dimension from q to q′, with q>q′, the following operations can performed be on the three matrices:

Qₜ =σ(L₁Mₜ); Kₜ=σ(L₂Mₜ); Vₜ=σ(L₃Mₜ),

where Lᵢ is in R^{q′×q}.The resulting matrices Q, K, V are all in R^{q′×d}. Performing a reduction of this sort can substantially improvement the overall parameter efficiency of a neural network model.

Next, the Q, K and V matrices [105] are then passed through the traditional self-attention computation as shown below:

M′ₜ=softmax(QₜK^{T}ₜ)Vₜ,

where the attention matrix QₜK^{T}ₜ is of dimension q′×q′. Then, in order to output a vector of dimension d, the following computation is performed:

mₜ=pM′ₜ,

Where p is in R^{1×q′} and m is in R^{d}. Note that this step can be excluded if q′ is set to 1 in the above step. Overall, given that the inputs to the illustrative embodiment are of dimension d and the outputs following the application of implicit attention are also of dimension d, the underlying neural network computes a straight-forward attention-based transformation of its input sequence, which can then be used to perform a downstream regression, classification, or data generation task. Standard training methods for optimizing neural networks can also be used to improve performance on these tasks while utilizing arbitrary loss functions.

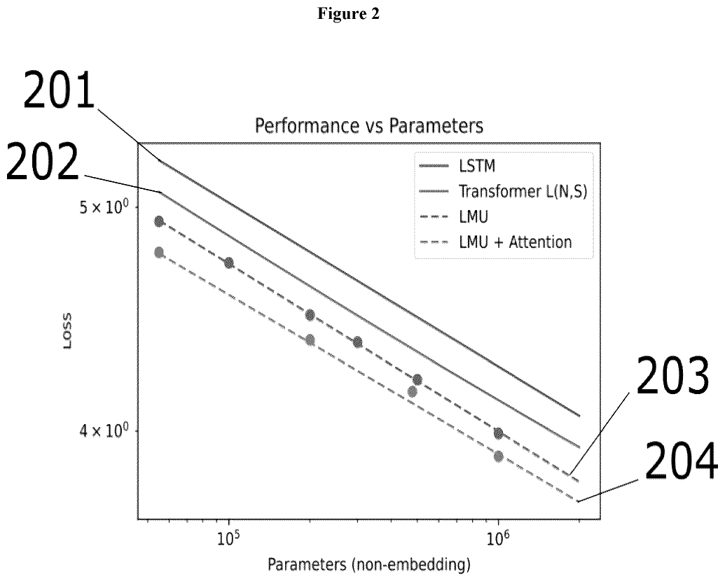

To provide a demonstration of the use of the disclosed methods and systems for implicitly computing pairwise sequence attention scores with sub-quadratic complexity in artificial neural networks, results from a number of benchmarking experiments are described herein. These experiments use a Legendre Memory Unit and an implicit attention module to perform an auto-regressive language modeling task. The model is trained on a publicly available internet text dataset called OpenWebText2 that consists of approximately eight billion tokens or words after preprocessing. The goal of language modeling is to accurately predict the next words in a sequence of text given some number of preceding words, and referring to FIG. 2, the loss metric is a numerical measure of performance on this task (with lower loss indicating higher performance). In keeping with well known scaling results from the literature on transformer-based natural language processing (Kaplan, Jared et al., “Scaling Laws for Neural Language Models”, ArXiv (2020)), the performance of this model follows a power law for the loss as a function of the number of parameters. Importantly, this power law fit for the LMU [203] model using both standard and implicit attention is substantially shifted downwards in

comparison with the fits for transformer [202] and LSTM [201] models, indicating that the LMU model achieves substantially higher levels of accuracy for given number of model parameters. A modified LMU model that includes standard self-attention achieves the best level of overall accuracy [204].

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A computer implemented method for sequence processing in artificial neural network models, comprising:
a. defining at least one preprocessing layer receiving an input sequence of vectors and producing, for each input vector, three output vectors; reshaping each output vector into an output matrix with one dimension corresponding to spatial information in the input sequence and the other corresponding to temporal information in the input sequence, such that the preprocessing layer implements at least one of:
i. a non-linear recurrent neural network (RNN) or a stack of non-linear RNNs;
ii. a linear RNN or a stack of linear RNNs where the recurrent linear transform is fixed;
iii. a convolution layer where the convolution operation involves weights that are either fixed or learned; or
iv. a convolution layer that implements a linear system by using the system's impulse response with the input vector in the Fourier domain;
b. defining at least one implicit-attention layer that processes the three output vectors reshaped into the three output matrices of the at least one preprocessing layer by:
i. taking an inner product between all pairs of rows in the first two output matrices so as to compute attention scores that model dependencies between row or column vectors in these matrices that represent temporal information from the original input sequence; and
ii. multiplying the resulting attention scores by the third output matrix to compute a final output vector that stores a compressed summary of all prior items in the input sequence;
and,
c. operating the resulting artificial neural network by using it to map a sequence of input vectors onto at least one final output vector to perform at least one task selected from the group consisting of pattern classification, signal processing, data representation and data generation.

2. The method of claim 1, wherein the linear recurrent transform in step a-ii is initialized randomly.

3. The method of claim 1, wherein the linear recurrent transform in step a-ii is chosen the from following set: discrete or continuous Legendre Transform, Fourier Transform, Hadamard Transform, Haar Transform, Laplace Transform, Cosine Transform, Fourier-Stieltjes, Gelfand Transform, or Harley Transform.

4. The method of claim 1, wherein any of the steps in a and b are followed by non-linearities.

5. The method of claim 1, further comprising one or more skip-connections that pass neural network activities from one network layer to another downstream network layer while skipping one or more intermediate layers.

6. The method of claim 1, wherein a single output matrix is produced by the preprocessing layer, and three copies of this output matrix are linearly or nonlinearly transformed before being provided as input to the implicit attention layer;

7. The method of claim 1, wherein three copies of the input sequence of vectors are provided as input to the preprocessing layer;

8. The method of claim 1, wherein a separate preprocessing layer is used to create each of the three output matrices;

9. The method of claim, wherein the input sequence of vectors is passed through three independent linear or nonlinear transformations before being provided as input to the preprocessing layer;

10. The method of claim 1, wherein the first of the output matrices of the preprocessing layer has a temporal dimensional with a length of one;

11. A system for pattern classification, signal processing, data representation, or data generation in neural networks, the system comprising:
a. at least one preprocessing layer receiving an input sequence of vectors and producing, for each input vector, three output vectors; reshaping each output vector into an output matrix with one dimension corresponding to spatial information in the input sequence and the other corresponding to temporal information in the input sequence, such that the preprocessing layer implements at least one of:
i. a non-linear recurrent neural network (RNN) or a stack of non-linear RNNs;
ii a linear RNN or a stack of linear RNNs where the recurrent linear transform is fixed;
iii. a convolution layer where the convolution operation involves weights that are either fixed or learned; or
iv. a convolution layer that implements a linear system by using the system's impulse response with the input vector in the Fourier domain;
b. at least one implicit-attention layer that processes the three output vectors reshaped into the three output matrices of the at least one preprocessing layer by:
i. taking an inner product between all pairs of rows in the first two output matrices so as to compute attention scores that model dependencies between row or column vectors in these matrices that represent temporal information from the original input sequence; and
ii. multiplying the resulting attention scores by the third output matrix to compute a final output vector that stores a compressed summary of all prior items in the input sequence;
wherein the system operates the neural network to map a sequence of input vectors onto at least one final output vector to perform at least one task selected from the group consisting of pattern classification, signal processing, data representation, and data generation.
